(19) United States
(12) Patent Application Publication
(10) Pub. No.: US 2025/0187152 A1
(43) Pub. Date: Jun. 12, 2025

(54) RATCHET WRENCH

(71) Applicants: CHENG-CHOU WU, Taichung City (TW); MING SHIN TOOLS CO., LTD., Taichung City (TW)

(72) Inventors: YUNG-SHUN CHEN, Taichung City (TW); CHENG-CHOU WU, Taichung City (TW)

(21) Appl. No.: 18/533,887

(22) Filed: Dec. 8, 2023

(51) Int. Cl. B25B 13/46; B25B 23/00

(52) U.S. Cl. CPC B25B 13/465; B25B 23/0028

(57) ABSTRACT

A ratchet wrench is provided, wherein the ratchet wrench includes: a rod body including a working end and a grip; a barrel rotatably connected to the working end and including limitation teeth and a positioning portion; a driving assembly rotatably disposed within the barrel and including a driving member including a connection portion, a lid covered on an end of the barrel, a fastener connecting the driving member and the lid, and a ratchet assembly including meshing teeth meshed with the limitation teeth, the fastener being axially non-movable relative to the driving member; and a locking mechanism including a pin movably received in the rod body, a locking elastic member received in the rod body and biasing the pin to interlock with the positioning portion, and a slidable member movably inserted in the rod body and including a buckle member buckled with the pin.

### BACKGROUND OF THE INVENTION

### Field of the Invention

The present invention relates to a ratchet wrench.

### Description of the Prior Art

Generally, when performing fastening operations, hand tools are used to drive the fasteners to achieve a labor-saving effect. In addition, in order to increase practicality and operating efficiency, there is a ratchet wrench, for example, provided with unidirectional rotation to improve the fastening operations.

However, the axial direction of the drive head of a conventional ratchet wrench is perpendicular to the length direction of the handle (lever arm), and the direction of the drive head is fixed. Therefore, the drive angle cannot be adjusted and changed, so it cannot be applied to various operating environments, causing operational inconvenience and seriously affecting operating efficiency.

The present invention is, therefore, arisen to obviate or at least mitigate the above-mentioned disadvantages.

### SUMMARY OF THE INVENTION

The main object of the present invention is to provide a ratchet wrench which is capable of being positioned to provide different driving angles and orientations.

To achieve the above and other objects, a ratchet wrench is provided, wherein the ratchet wrench includes: a rod body including a longitudinal direction, and a working end and a grip at two ends in the longitudinal direction; a barrel connected to the working end and rotatable about an axis transverse to the longitudinal direction, an inner surface of the barrel including a plurality of limitation teeth arranged around the axis, an outer surface of the barrel including at least one positioning portion; a driving assembly rotatably disposed within the barrel and including a driving member, a lid, a fastener and a ratchet assembly, the driving member including a connection portion projecting out of the barrel and configured to be assembled with an object, the lid being covered on an end of the barrel opposite to the connection portion, the driving member and the lid being connected to each other by the fastener, the fastener being axially non-movable relative to the driving member, the ratchet assembly being disposed between the driving member, the lid and the barrel, the ratchet assembly including a plurality of meshing teeth meshed with the plurality of limitation teeth, the ratchet assembly being movable by operation of the lid; and a locking mechanism including a pin movably received in the rod body, a locking elastic member received in the rod body, and a slidable member radially inserted in the rod body, the slidable member being movable relative to the rod body in the longitudinal direction, the slidable member including a buckle member, the buckle member being inserted in and buckled with the pin, the locking elastic member biasing the pin toward the barrel so that the pin and the at least one positioning portion are interlocked with each other.

The present invention will become more obvious from the following description when taken in connection with the accompanying drawings, which show, for purpose of illustrations only, the preferred embodiment(s) in accordance with the present invention.

### BRIEF DESCRIPTION OF THE DRAWINGS

FIG. 1 is a stereogram of an exemplary embodiment of the present invention;

FIG. 2 is a breakdown drawing of an exemplary embodiment of the present invention;

FIG. 3 is a cross-sectional view of an exemplary embodiment of the present invention; and

FIGS. 4 and 5 are drawings showing operation of a ratchet wrench of an exemplary embodiment of the present invention.

### DETAILED DESCRIPTION OF THE PREFERRED EMBODIMENTS

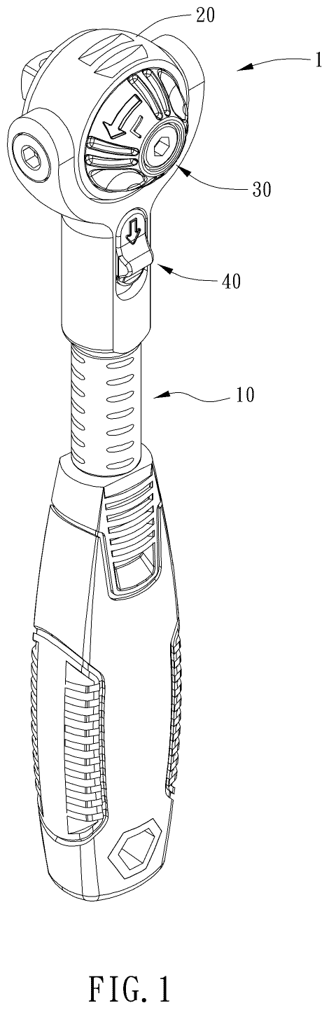

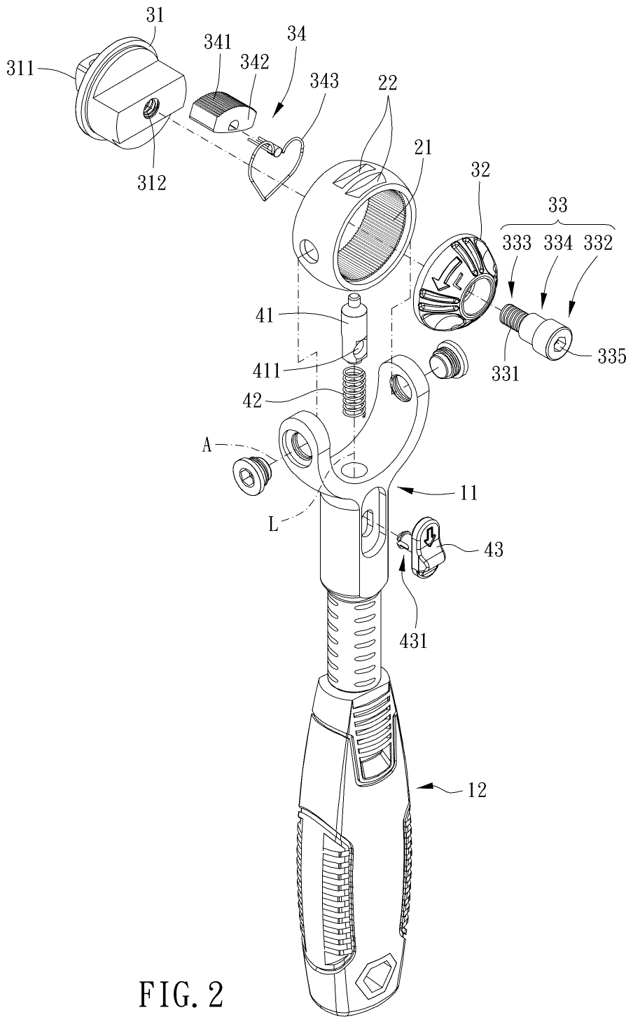

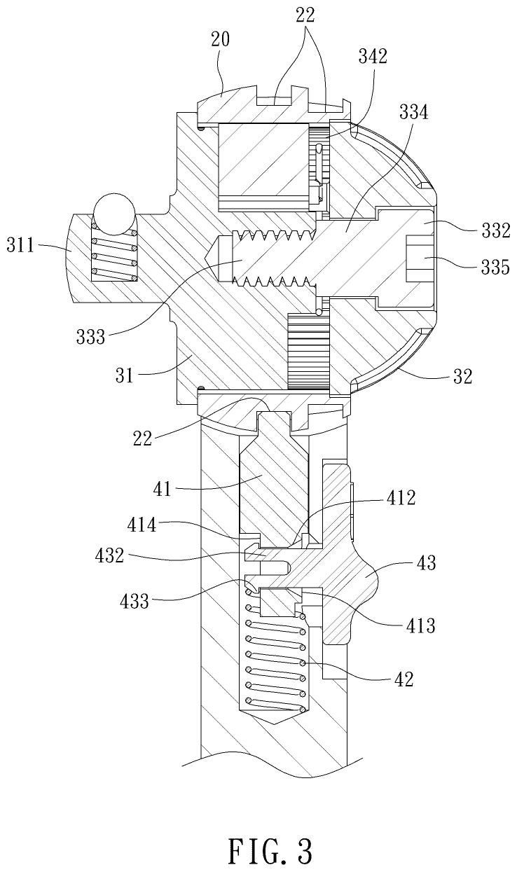

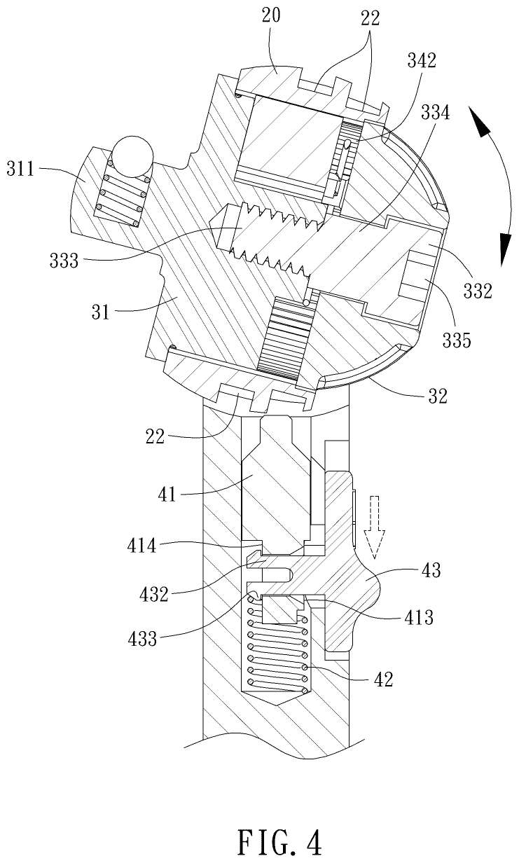

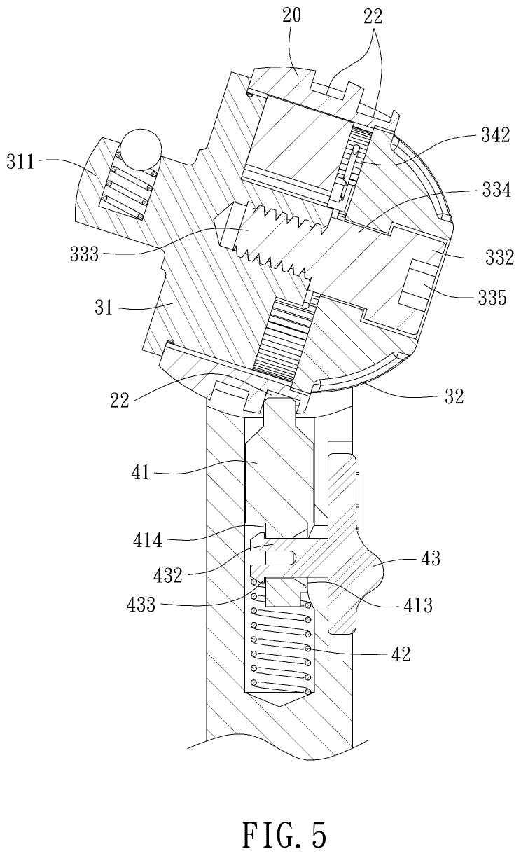

Please refer to FIGS. 1 to 5 for an exemplary embodiment of the present invention. A ratchet wrench 1 of the present invention includes a rod body 10, a barrel 20, a driving assembly 30 and a locking mechanism 40.

The rod body 10 includes a longitudinal direction L, and a working end 11 and a grip 12 at two ends in the longitudinal direction L. The barrel 20 is connected to the working end 11 and rotatable about an axis A transverse to the longitudinal direction L. An inner surface of the barrel 20 includes a plurality of limitation teeth 21, and an outer surface of the barrel 20 includes at least one positioning portion 22. The driving assembly 30 is rotatably disposed within the barrel 20, the driving assembly 30 includes a driving member 31, a lid 32, a fastener 33 and a ratchet assembly 34, the driving member 31 includes a connection portion 311 projecting out of the barrel 20 and configured to be assembled with an object (such as a socket), the lid 32 is covered on an end of the barrel 20 opposite to the connection portion 311, the driving member 31 and the lid 32 are connected to each other by the fastener 33, the fastener 33 is axially non-movable relative to the driving member 31, the ratchet assembly 34 is disposed between the driving member 31, the lid 32 and the barrel 20, the ratchet assembly 34 includes a plurality of meshing teeth 341 meshed with the plurality of limitation teeth 21, and the ratchet assembly 34 is movable by operation of the lid 32 so that the driving member 31 is unidirectionally rotatable clockwise or counterclockwise. The locking mechanism 40 includes a pin 41 movably received in the rod body 10, a locking elastic member 42 received in the rod body 10, and a slidable member 43 radially inserted in the rod body 10. The slidable member 43 is movable relative to the rod body 10 in the longitudinal direction L, the slidable member 43 includes a buckle member 431, the buckle member 431 is inserted in and buckled with the pin 41, and the locking elastic member 42 biases the pin 41 toward the barrel 20 so that the pin 41 and the at least one positioning portion 22 are interlocked with each other. As such, the driving assembly 30 is capable of being positioned to provide different driving angles and orientations.

The ratchet assembly 34 further includes a detent 342 and a switching elastic member 343, and the switching elastic member 343 biases the detent 342 so that the plurality of meshing teeth 341 are meshed with the plurality of limitation teeth 21, thus resulting in unidirectional rotation of the driving member 31. Preferably, the at least one positioning portion includes a plurality of positioning portions 22, the plurality of positioning portions 22 are arranged around the axis A so that the driving assembly 30 is capable of being positioned to provide different driving angles and orientations. In this embodiment, the plurality of positioning portions 22 are recesses, and depths of the plurality of positioning portions 22 are gradually deeper than one another in a direction directed inward from a periphery of the barrel 20 and are arranged in a high and low manner, which provides good positioning effect because of considering the spatial relationship of the positioning portions 22 and the outer contour profile of the barrel 20.

The driving member 31 further includes a threaded hole 312, the fastener 33 includes a threaded section 331 screwed to the threaded hole 312, and thus it is easy to assembly, disassemble and maintain. The fastener 33 further includes a head section 332, a distal section 333 and a middle section 334 connected between the head section 332 and the distal section 333. The distal section 333 includes the threaded section 331, and the middle section 334 has a diametric dimension smaller than a diametric dimension of the head section 332 and larger than a diametric dimension of the distal section 333. The lid 32 is restricted between the head section 332 and the driving member 31. The middle section 334 is axially abutted against the driving member 31, which provides a stable structure and can precisely limit the position to maintain the detent 342. Preferably, an end of the fastener 33 includes a positioning structure 335 interlockable with the pin 41 so that the connection portion 311 of the driving member 31 can be positioned to be parallel to the longitudinal direction L, achieving fast turning operations under a lower-torque condition.

The buckle member 431 includes two legs 432 distanced from each other, each of the two legs 432 includes a hook 433 projecting radially, the pin 41 includes an insertion hole 411, the hooks 433 of the two legs 432 have a distance larger than a diametric dimension of the insertion hole 411, and the two legs 432 are disposed through the insertion hole 411 and the hooks 433 of the two legs 432 hook on a portion of the pin 41 around the insertion hole 411. As such, the buckle member 431 can be quickly, effectively and reliably inserted into bucked with the pin 41. Preferably, an end of the insertion hole 411 opposite to the hooks 433 of the two legs 432 includes an expanding section 412, which is conducive to installation of the buckle member 431. The pin 41 includes a shallow recessed portion 413 and a deep recessed portion 414, respectively. The two legs 432 are disposed through the shallow recessed portion 413 and the deep recessed portion 414, the expanding section 412 is disposed on the shallow recessed portion 413, and the hooks 433 of the two legs 432 are located within the deep recessed portion 414, thus being compact. Moreover, the locking elastic member 42 is abutted against the hook 433 of one of the two legs 432, which provides the stability of the slideable member 43.

Although particular embodiments of the invention have been described in detail for purposes of illustration, various modifications and enhancements may be made without departing from the spirit and scope of the invention. Accordingly, the invention is not to be limited except as by the appended claims.

What is claimed is:

1. A ratchet wrench including:
a rod body including a longitudinal direction, and a working end and a grip at two ends in the longitudinal direction;
a barrel connected to the working end and rotatable about an axis transverse to the longitudinal direction, an inner surface of the barrel including a plurality of limitation teeth arranged around the axis, an outer surface of the barrel including at least one positioning portion;
a driving assembly rotatably disposed within the barrel and including a driving member, a lid, a fastener and a ratchet assembly, the driving member including a connection portion projecting out of the barrel and configured to be assembled with an object, the lid being covered on an end of the barrel opposite to the connection portion, the driving member and the lid being connected to each other by the fastener, the fastener being axially non-movable relative to the driving member, the ratchet assembly being disposed between the driving member, the lid and the barrel, the ratchet assembly including a plurality of meshing teeth meshed with the plurality of limitation teeth, the ratchet assembly being movable by operation of the lid; and
a locking mechanism including a pin movably received in the rod body, a locking elastic member received in the rod body, and a slidable member radially inserted in the rod body, the slidable member being movable relative to the rod body in the longitudinal direction, the slidable member including a buckle member, the buckle member being inserted in and buckled with the pin, the locking elastic member biasing the pin toward the barrel so that the pin and the at least one positioning portion are interlocked with each other.

2. The ratchet wrench of claim 1, wherein the ratchet assembly includes a detent and a switching elastic member, and the switching elastic member biases the detent so that the plurality of meshing teeth are meshed with the plurality of limitation teeth.

3. The ratchet wrench of claim 1, wherein the at least one positioning portion includes a plurality of positioning portions, the plurality of positioning portions are arranged around the axis, the plurality of positioning portions are recesses, and depths of the plurality of positioning portions are gradually deeper than one another in a direction directed inward from a periphery of the barrel and are arranged in a high and low manner.

4. The ratchet wrench of claim 1, wherein the driving member further includes a threaded hole, the fastener includes a threaded section screwed to the threaded hole, the fastener further includes a head section, a distal section and a middle section connected between the head section and the distal section, the distal section includes the threaded section, the middle section has a diametric dimension smaller than a diametric dimension of the head section and larger than a diametric dimension of the distal section, and the lid is restricted between the head section and the driving member.

5. The ratchet wrench of claim 4, wherein the middle section is axially abutted against the driving member.

6. The ratchet wrench of claim 1, wherein the buckle member includes two legs distanced from each other, each of the two legs includes a hook projecting radially, the pin includes an insertion hole, the hooks of the two legs have a distance larger than a diametric dimension of the insertion hole, the two legs are disposed through the insertion hole, and the hooks of the two legs hook on a portion of the pin around the insertion hole.

7. The ratchet wrench of claim 6, wherein an end of the insertion hole opposite to the hooks of the two legs includes an expanding section.

8. The ratchet wrench of claim 7, wherein opposing sides of a distal end of the pin includes a shallow recessed portion and a deep recessed portion, respectively, the two legs are disposed through the shallow recessed portion and the deep recessed portion, the expanding section is disposed on the shallow recessed portion, and the hooks of the two legs are located within the deep recessed portion.

9. The ratchet wrench of claim 6, wherein the locking elastic member is abutted against the hook of one of the two legs.

10. The ratchet wrench of claim 1, wherein an end of the fastener includes a positioning structure interlockable with the pin.
